(19) United States
(12) Patent Application Publication
(10) Pub. No.: US 2023/0246212 A1
(43) Pub. Date: Aug. 3, 2023

(54) FUEL CELL SYSTEM AND METHOD OF OPERATING THE SAME

(71) Applicant: MITSUBISHI HEAVY INDUSTRIES, LTD., Tokyo (JP)

(72) Inventors: Yasushi IWAI, Tokyo (JP); Katsuhiko YOKOHAMA, Tokyo (JP); Norihisa MATAKE, Tokyo (JP); Ryutaro MORI, Tokyo (JP)

(73) Assignee: MITSUBISHI HEAVY INDUSTRIES, LTD., Tokyo (JP)

(21) Appl. No.: 18/099,552

(22) Filed: Jan. 20, 2023

(30) Foreign Application Priority Data
Feb. 3, 2022 (JP) 2022-015290

(51) Int. Cl. H01M 8/0662; H01M 8/04119; H01M 8/04014; H01M 8/04746; H01M 8/12

(52) U.S. Cl. CPC H01M 8/0662; H01M 8/04119; H01M 8/04022; H01M 8/04753; H01M 8/12; H01M 2008/1293

(57) ABSTRACT

A fuel cell system includes: a fuel cell including a fuel electrode and an air electrode; a fuel electrode fuel line configured to supply fuel gas to the fuel electrode; a polluted exhaust line configured to supply polluted exhaust containing contaminants discharged from a facility to the air electrode; and an air electrode fuel line configured to supply fuel gas to the air electrode.

### CROSS-REFERENCE TO RELATED APPLICATIONS

This application claims the benefit of priority to Japanese Patent Application Number 2022-015290 filed on Feb. 3, 2022. The entire contents of the above-identified application are hereby incorporated by reference.

### TECHNICAL FIELD

The disclosure relates to a fuel cell system and a method of operating the same.

### RELATED ART

JP 2008-281330 A discloses an air conditioner configured to remove odor components adhering to walls, curtains, or the like in a room, contaminants such as inactivate allergens and viruses that float in or adhere to surfaces in a room, and sterilize contaminants such as mold and bacteria.

### SUMMARY

In a facility such as a hospital that deals with contaminants such as bacteria and viruses, polluted exhaust from the facility is preferably purified in a manner suited to the amount of discharged polluted exhaust to prevent the spread of such contaminants. However, it is not always easy to install a purification device for the sole purpose of purifying polluted exhaust due to factors such as installation space restrictions and an increase in cost.

In view of the foregoing, an object of the disclosure is to provide a fuel cell system and a method of operating the same, which can generate electric power while purifying polluted exhaust in a manner suited to the amount of discharged polluted exhaust.

To achieve the above object, a fuel cell system according to at least one embodiment of the disclosure includes:

a fuel cell including a fuel electrode and an air electrode;

a fuel electrode fuel line configured to supply fuel gas to the fuel electrode;

a polluted exhaust line configured to supply polluted exhaust containing contaminants discharged from a facility to the air electrode; and

an air electrode fuel line configured to supply fuel gas to the air electrode.

To achieve the above object, in a method of operating a fuel cell system according to at least one embodiment of the disclosure,

the fuel cell system includes:

a fuel cell including a fuel electrode and an air electrode;

a fuel electrode fuel line configured to supply fuel gas to the fuel electrode;

a polluted exhaust line configured to supply polluted exhaust containing contaminants discharged from a facility to the air electrode; and

an air electrode fuel line configured to supply fuel gas to the air electrode,

in which the method of operating the fuel cell system includes adjusting a flow rate of fuel gas supplied from the air electrode fuel line to the air electrode based on a polluted exhaust amount being an amount of the polluted exhaust discharged from the facility.

At least one embodiment of the disclosure provides a fuel cell system and a method of operating the same, which can generate electric power while purifying polluted exhaust in a manner suited to the amount of discharged polluted exhaust.

### BRIEF DESCRIPTION OF DRAWINGS

The disclosure will be described with reference to the accompanying drawings, wherein like numbers reference like elements.

FIG. 1 is a schematic diagram illustrating a fuel cell system 2A, which is one embodiment of a fuel cell system 2.

FIG. 2 is a diagram illustrating an example of an operation pattern of the fuel cell system 2.

FIG. 3 is a diagram illustrating another example of an operation pattern of the fuel cell system 2.

FIG. 4 is a schematic diagram illustrating a fuel cell system 2B, which is another embodiment of the fuel cell system 2.

FIG. 5 is a diagram illustrating an example of a hardware configuration of a controller 100.

FIG. 6 is a block diagram illustrating an example of a functional configuration of the controller 100 illustrated in FIG. 5.

FIG. 7 is a diagram illustrating an example of a schematic flow of load control for an SOFC 14 using the controller 100 illustrated in FIGS. 5 and 6.

FIG. 8 is a diagram illustrating an example of a detailed flow of air intake control in S13 of FIG. 7.

FIG. 9 is a diagram illustrating an example of a detailed flow of heat amount control in S14 of FIG. 7.

FIG. 10 is a diagram illustrating the relationship between amounts of hot water and steam, which can be generated by a heat exchange apparatus 54, for individual additional fuel amounts.

FIG. 11 is a schematic diagram illustrating a portion of a fuel cell system 2C, which is another embodiment of the fuel cell system 2.

### DESCRIPTION OF EMBODIMENTS

Some embodiments of the disclosure will now be described with reference to the accompanying drawings. However, dimensions, materials, shapes, relative positions and the like of components described in the embodiments or illustrated in the drawings shall be interpreted as illustrative only and not intended to limit the scope of the disclosure.

For example, expressions indicating relative or absolute arrangement such as “in a direction”, “along a direction”, “parallel”, “orthogonal”, “center”, “concentric”, or “coaxial” shall not be construed as indicating only such arrangement in a strict literal sense but also as indicating a state of being relatively displaced by a tolerance, or by an angle or a distance as long as the same function can be obtained.

For example, expressions indicating a state of being equal such as “same”, “equal”, or “uniform” shall not be construed as indicating only a state of being strictly equal but also as indicating a state in which there is a tolerance or a difference as long as the same function can be obtained.

For example, expressions indicating a shape such as a rectangular shape or a tube shape shall not be construed as only indicating a shape such as a rectangular shape or a tube shape in a strict geometrical sense but also as indicating a shape including depressions, protrusions, and chamfered corners as long as the same effect can be obtained.

On the other hand, expressions such as “provided”, “comprise”, “contain”, “include”, or “have” are not intended to be exclusive of other components.

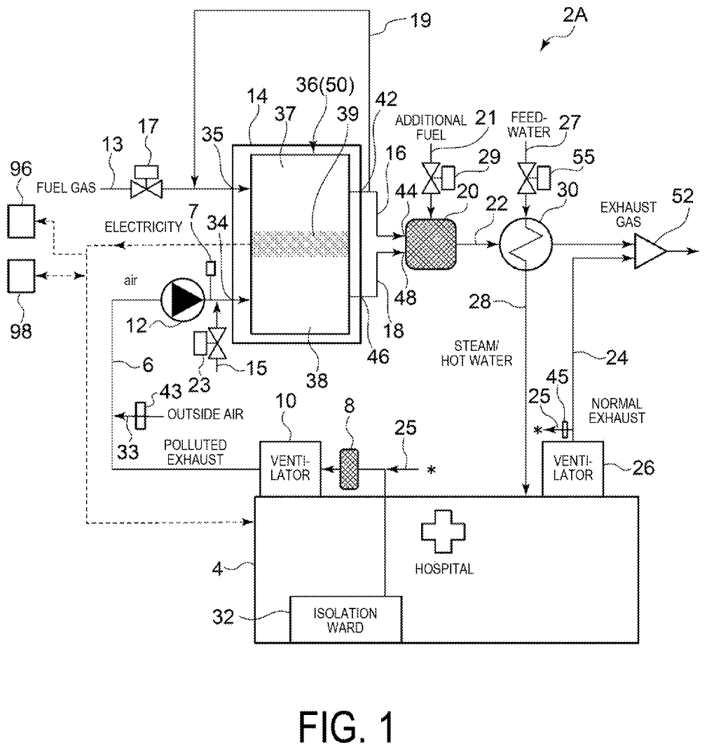

FIG. 1 is a schematic diagram illustrating a fuel cell system 2A, which is one embodiment of a fuel cell system 2. In the example illustrated in FIG. 1, the fuel cell system 2A is configured to purify polluted exhaust containing contaminants, which is discharged from a hospital 4 (a facility such as a hospital that deals with contaminants such as bacteria and viruses).

The fuel cell system 2A illustrated in FIG. 1 includes a polluted exhaust line 6, a filter 8, a ventilator 10, an outside air intake 33, a blower 12, a fuel electrode fuel line 13, an SOFC 14, an air electrode fuel line 15, an exhaust fuel gas line 16, an exhaust air line 18, a recirculation fuel line 19, a combustor 20, an additional fuel line 21, a combustion gas line 22, a normal exhaust line 24, a normal exhaust supply line 25, a ventilator 26, a feedwater line 27, a heat supply line 28, a heat exchanger 30 (heat exchange apparatus), and a mixer 52. The SOFC 14 is a solid oxide fuel cell.

The polluted exhaust line 6 is formed of, for example, a pipe or a duct, and is configured to supply polluted exhaust containing contaminants discharged from the hospital 4 to an air inlet 34 of the SOFC 14. The contaminants include, for example, bacteria or viruses. One end of the polluted exhaust line 6 is connected to an isolation ward 32 used for isolating infectious disease patients in the hospital 4, and the other end of the polluted exhaust line 6 is connected to the air inlet 34 of the SOFC 14. A flow meter 7 for measuring the air intake of the SOFC 14 is provided downstream of the blower 12 in the polluted exhaust line 6. The air intake of the SOFC 14 refers to the total flow rate of air supplied from the polluted exhaust line 6 and the outside air intake 33 to an air electrode 38 of the SOFC 14.

The filter 8 is provided in the polluted exhaust line 6 between the isolation ward 32 and the ventilator 10. The filter 8 is configured to remove some or all of the microparticles in the polluted exhaust flowing in the polluted exhaust line 6. Permeated contaminants such as bacteria and viruses that cannot be removed by the filter 8 flow through the polluted exhaust line 6.

The ventilator 10 is provided in the polluted exhaust line 6 between the filter 8 and the blower 12. The ventilator 10 is configured to intake polluted exhaust from the isolation ward 32 via the filter 8. This causes the isolation ward 32 to function, for example, as a negative pressure chamber.

The blower 12 is provided in the polluted exhaust line 6 between the ventilator 10 and the SOFC 14. The blower 12 boosts the total flow rate of the polluted exhaust flowing through the polluted exhaust line 6 and inflow from the outside air intake 33, if any, and supplies these to the air inlet 34 of the SOFC 14.

The fuel electrode fuel line 13 is configured of, for example, a pipe, and is configured to supply fuel gas to the fuel gas inlet 35 of the SOFC 14. The fuel gas that can be supplied to and used at the fuel gas inlet 35 of the SOFC 14 includes: hydrogen (H2); carbon monoxide (CO); methane (CH4); hydrocarbon-based gas such as biogas; city gas; natural gas; and gasified gas produced by a gasification facility from carbon-containing raw materials such as oil, methanol, and coal. The fuel electrode fuel line 13 is provided with a flow control valve 17 capable of adjusting the flow rate of the fuel gas supplied from the fuel electrode fuel line 13 to the SOFC 14.

The SOFC 14 includes a power generating unit 36 configured to generate power at a predetermined operating temperature (e.g., 500° C. to 900° C.) using the fuel gas supplied from the fuel electrode fuel line 13 via the fuel gas inlet 35 and the polluted exhaust (more specifically, oxygen in the polluted exhaust) acting as an oxidant, which is supplied from the polluted exhaust line 6 via the air inlet 34. The air supplied to the SOFC 14 includes all of the polluted exhaust from the ventilator 10. In a case where the amount of polluted exhaust required to generate the electric power required by the SOFC 14 is deficient, normal exhaust from the ventilator 26 and/or outside air taken in from the outside air intake 33 (air) are used together with the polluted exhaust. The outside air intake 33 includes a flow adjustment valve 43 serving as an outside air regulator capable of adjusting the flow rate of outside air taken into the polluted exhaust line 6. The outside air intake 33 is supplied with pressurized outside air.

The power generating unit 36 includes a fuel electrode 37, an air electrode 38 and an electrolyte 39. The power generating unit 36 generates power at the predetermined operating temperature when fuel gas is supplied to the fuel electrode 37 from the fuel electrode fuel line 13 via the fuel gas inlet 35 and polluted exhaust is supplied to the air electrode 38 from the polluted exhaust line 6 via the air inlet 34. In the present embodiment, the power generating unit 36 of the SOFC 14 constitutes a polluted exhaust purification section 50, which purifies the polluted exhaust supplied from the polluted exhaust line 6 by utilizing the reaction heat of the SOFC 14 (reaction heat of an electrochemical reaction using the fuel gas and the oxygen in the polluted exhaust) to pass the polluted exhaust through a high temperature region maintained at the predetermined operating temperature. The electric power generated at the SOFC 14 is converted into predetermined electric power by a power converter (e.g., an inverter) such as a power conditioner (not illustrated) or a transformer, and supplied to the hospital 4 (outside the fuel cell system 2A), other facilities (e.g., a data center 96), a power storage device 98 (battery), or the like for use.

An air electrode fuel line 15 is configured of a pipe, for example, and is capable of supplying fuel gas to the air electrode 38. As the fuel gas supplied to the air electrode 38 by the air electrode fuel line 15, the same kind of gas as the fuel supplied by the fuel electrode fuel line 13 may be used, or identical gases may be used. In the illustrated example, the air electrode fuel line 15 is connected to the polluted exhaust line 6, and the fuel gas supplied from the air electrode fuel line 15 is mixed with the polluted exhaust supplied from the polluted exhaust line 6 and supplied to the air electrode 38. The air electrode fuel line 15 is provided with a flow control valve 23 capable of adjusting a flow rate of the fuel gas supplied from the air electrode fuel line 15 to the air electrode 38 of the SOFC 14.

The exhaust fuel gas line 16 is configured of, for example, a pipe or a duct, and is configured to supply exhaust fuel gas discharged from the SOFC 14 to an exhaust fuel gas inlet 44 of the combustor 20. One end of the exhaust fuel gas line 16 is connected to an exhaust fuel gas outlet 42 of the SOFC 14, and the other end of the exhaust fuel gas line 16 is connected to the exhaust fuel gas inlet 44 of the combustor 20.

The exhaust air line 18 is configured of, for example, a pipe or a duct, and is configured to supply the exhaust air discharged from the SOFC 14 to an exhaust air inlet 48 of the combustor 20. One end of the exhaust air line 18 is connected to an exhaust air outlet 46 of the SOFC 14, and the other end of the exhaust air line 18 is connected to the exhaust air inlet 48 of the combustor 20.

The recirculation fuel line 19 branches from the exhaust fuel gas line 16 and is connected to the fuel electrode fuel line 13. The recirculation fuel line 19 is configured so that the exhaust fuel gas discharged from the SOFC 14 can be recycled to the fuel electrode fuel line 13, as required, for power generation by the power generating unit 36.

The combustor 20 combusts the exhaust fuel gas of the SOFC 14. In the illustrated embodiment, the exhaust fuel gas supplied from the exhaust fuel gas line 16 and the exhaust air supplied from the exhaust air line 18 are mixed and combusted to produce combustion gas. The combustion gas generated in the combustor 20 is supplied to the heat exchanger 30 via the combustion gas line 22. The feedwater line 27 is connected to the heat exchanger 30, and the heat exchanger 30 generates steam or hot water by heating water (e.g., pure water or tap water) supplied from the feedwater line 27 using the combustion gas generated in the combustor 20. The feedwater line 27 is provided with a flow control valve 55 capable of adjusting the flow rate of water supplied to the heat exchanger 30. The heat supply line 28 connects the heat exchanger 30 and a heat utilization facility (not illustrated) of the hospital 4, and steam or hot water generated at the heat exchanger 30 is supplied to the heat utilization facility of the hospital 4 via the heat supply line 28.

The additional fuel line 21 is configured to supply additional fuel (additional heating fuel) to the combustor 20. For example, in a case where the heat exchanger 30 cannot generate sufficient steam or hot water using only the thermal energy generated by the combustion of exhaust fuel gas supplied from the exhaust fuel gas line 16 for the heat demand (steam demand or hot water demand) of the hospital 4, the heat demand of the hospital 4 can be satisfied by supplying additional fuel (additional heating fuel) to the combustor 20 from the additional fuel line 21. The additional fuel line 21 is provided with a flow control valve 29 serving as an additional fuel regulator capable of adjusting the flow rate of the additional fuel added from the additional fuel line 21 to the combustor 20.

The normal exhaust line 24 is configured of, for example, a pipe or a duct, and is configured such that normal exhaust discharged by the ventilator 26 from a place other than the isolation ward 32 in the hospital 4 is discharged to the outside of the hospital 4. Normal exhaust is exhaust gas that has contaminants below a permissible concentration or does not contain any contaminants. The concentration of contaminants in the normal exhaust is lower than the concentration of contaminants in the polluted exhaust.

The normal exhaust supply line 25 branches from the normal exhaust line 24 and is connected to the polluted exhaust line 6. The normal exhaust supply line 25 is configured such that the normal exhaust in the normal exhaust line 24 can be supplied to the polluted exhaust line 6. The normal exhaust supply line 25 is provided with a flow adjustment valve 45 serving as a normal exhaust regulator capable of adjusting the flow rate of the normal exhaust supplied from the normal exhaust line 24 to the polluted exhaust line 6.

The mixer 52 is configured to mix the combustion gas flowing through the combustion gas line 22 with the normal exhaust flowing through the normal exhaust line 24. The mixer 52 is provided downstream of the heat exchanger 30 in the combustion gas line 22. The combustion gas discharged from the combustor 20 and the normal exhaust discharged from the hospital 4 are mixed in the mixer 52 before being discharged.

With the configuration described above, the polluted exhaust supplied from the isolation ward 32 of the hospital 4 via the polluted exhaust line 6 can be purified by being passed through the high temperature region (power generating unit 36) of the SOFC 14. As a result, the polluted exhaust can be purified while the SOFC 14 generates electric power. For example, the electric power generated by the SOFC 14 can be utilized in the hospital 4, and bacteria or viruses in the polluted exhaust discharged from the hospital 4 can be killed to greatly reduce the amount of bacteria or viruses in the polluted exhaust. As a result, health risks to visitors to the hospital 4 and neighboring residents can be reduced.

Since the SOFC 14 takes in a large amount of air from the air inlet 34 and uses this air for power generation, a large amount of polluted air can be purified while the SOFC 14 generates power.

Further, since the SOFC 14 is operated 24 hours a day to constantly purify the polluted exhaust and the only exhaust substance when hydrogen is used as a fuel is water, the SOFC 14 is suitable for use in the hospital 4. In addition, the SOFC 14 can be operated with fuel gas during a power failure and water can be obtained from the exhaust gas of the SOFC 14 during a water outage. Thus, using the fuel cell system 2A is also advantageous in terms of disaster prevention.

Even when the amount of polluted exhaust is likely to be excessive compared to the air intake of the SOFC 14 when the amount of polluted exhaust discharged from the hospital 4 via the polluted exhaust line 6 increases, the rotational speed of the blower 12 can be increased to appropriately supply the polluted exhaust to the SOFC 14. Furthermore, in a case where the flow rate of the polluted exhaust discharged from the hospital 4 via the polluted exhaust line 6 in the fuel cell system 2A increases, the air intake of the SOFC 14 increases, and when nothing is done, the temperature of the air electrode 38 decreases and the cleaning action of the polluted exhaust of the SOFC 14 decreases. However, with the above fuel cell system 2A, even when the air intake of the SOFC 14 increases due to an increase in the flow rate of the polluted exhaust discharged from the hospital 4 via the polluted exhaust line 6, since the fuel gas is supplied from the air electrode fuel line 15 to the air electrode 38 and the fuel gas is combusted (power generation chamber combustion) on the air electrode 38 side by the catalytic action of the air electrode 38, a decrease in the internal temperature of the SOFC 14 due to the increase in the flow rate of the polluted exhaust can be suppressed by the heat of combustion on the air electrode 38 side. Thus, even when the amount of polluted exhaust discharge fluctuates, electric power can be generated by the SOFC 14 while the polluted exhaust is appropriately purified by being passed through the high temperature region (power generating unit 36) of the SOFC 14.

Since the fuel cell system 2A is provided with the flow adjustment valve 43 capable of adjusting the flow rate of the outside air taken into the polluted exhaust line 6, when the amount of polluted exhaust discharged from the hospital 4 is small compared to the amount of air required to generate the electric power required by the SOFC 14 in the hospital 4, the flow adjustment valve 43 can be used to ensure that an appropriate amount of the outside air is taken into the polluted exhaust line 6 to meet the required amount.

Since the fuel cell system 2A is provided with the flow adjustment valve 45 capable of adjusting the flow rate of the normal exhaust supplied from the normal exhaust supply line 25 to the polluted exhaust line 6, when the amount of polluted exhaust from the hospital 4 is small compared to the amount of air required to generate the electric power required by the SOFC 14 in the hospital 4, the flow adjustment valve 45 can be used to ensure that an appropriate amount of the normal exhaust is taken into the polluted exhaust line 6 to meet the required amount.

In the fuel cell system 2A, the exhaust fuel gas discharged from the SOFC 14 is combusted by the combustor 20 using the exhaust air discharged from the SOFC 14 to generate combustion gas. Further, steam and/or hot water generated at the heat exchanger 30 using the combustion gas can be supplied to the hospital 4 via the heat supply line 28. With this configuration, the steam and/or hot water generated at the heat exchanger 30 can be utilized to satisfy the steam demand or hot water demand of the hospital 4 while the polluted exhaust discharged from the hospital 4 is purified.

The fuel cell system 2A is provided with the additional fuel line 21 configured to supply additional fuel to the combustor 20. The amount of heat (the amount of steam and/or hot water) that can be supplied to the hospital 4 can be adjusted by adjusting the amount of additional fuel supplied to the combustor 20. With this configuration, for example, the electric output of the SOFC 14 can satisfy the electric power demand of the hospital 4, and the fuel cell system 2A can be operated in a manner that satisfies the steam demand and/or the hot water demand of the hospital 4 by adjusting the amount of additional fuel supplied to the combustor 20.

Further, in the fuel cell system 2A, hot water can be stored in a hot well 67 by utilizing the waste heat of the SOFC 14 at night or other times when the hot water demand is low. This hot water can be supplied to a facility from the hot well 67 during the day when the demand for hot water is high. As a result, an increase in the installed capacity of the SOFC 14 can be suppressed, which suppresses an increase in the equipment costs of the SOFC 14.

For example, in the fuel cell system 2A, the installed capacity of the SOFC 14 may be determined to meet all peaks of the heat demand, amount of polluted exhaust, and electric power demand. The operating conditions of the SOFC 14 may also be varied to meet all of the heat demand, the amount of polluted exhaust, and the electric power demand for different seasons and for individual hours. In the fuel cell system 2A, when the thermal load at night is low and surplus steam is generated, this surplus steam may be utilized for heating at night in a cold region, for example, or for planning sterilization treatment using an autoclave at night, for example.

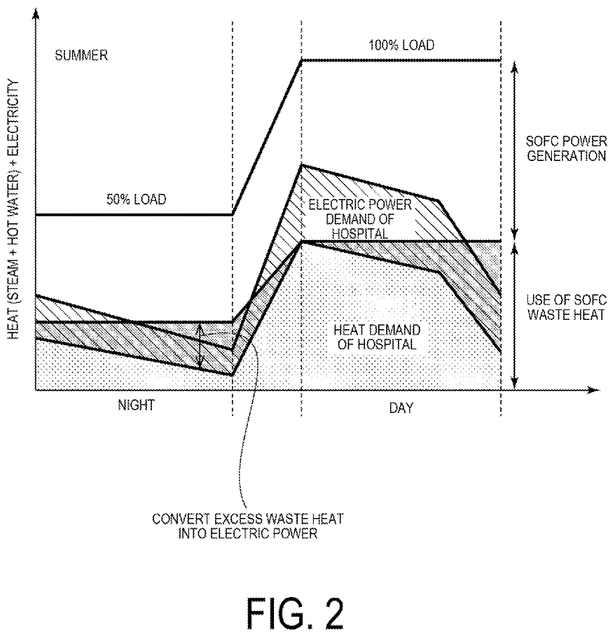

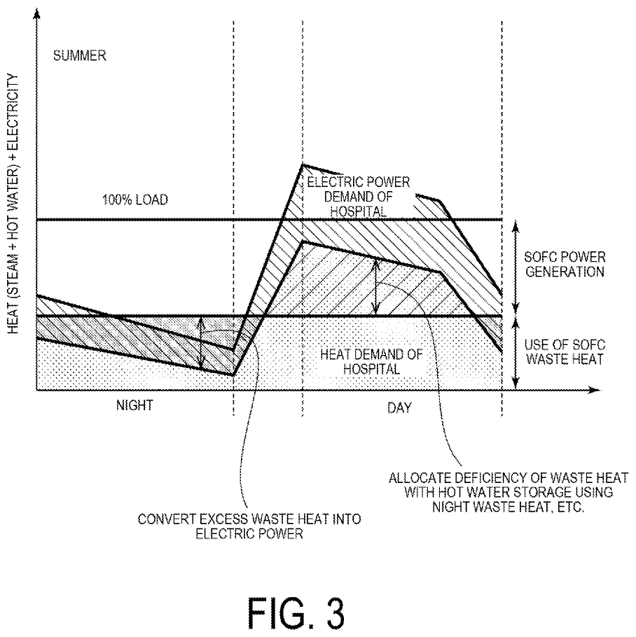

Referring now to FIG. 2 and FIG. 3, several examples of an operation pattern of the fuel cell system 2 will be described. FIG. 2 and FIG. 3 are diagrams illustrating examples of the operation pattern of the fuel cell system 2.

In the example illustrated in FIG. 2, the installed capacity of the SOFC 14 is designed to meet the peak heat demand of the hospital 4. For example, the SOFC 14 operates at 50% load at night and at 100% load during the day. When the SOFC 14 is operated under different loads at night and day as illustrated in FIG. 2, the load level of the SOFC 14 may be adjusted seasonally. In the example illustrated in FIG. 2, the heat demand (steam demand and/or hot water demand) of the hospital 4 is satisfied by the waste heat of the SOFC 14, and unnecessary waste heat of the SOFC 14 is converted into electric power by low-temperature heat recovery power generation using, for example, an organic Rankine cycle, or by being radiated. Of the electric power generated at the

SOFC 14, surplus electric power not used in the hospital 4 is supplied to another facility such as the data center 96. When the excess power not used in the hospital 4 is excessive compared to the electric power demand of the other facility such as the data center 96 (e.g., a certain electric power demand regardless of time), this excess may be charged to the power storage device 98. When the excess power not used in the hospital 4 is deficient compared to the electric power demand of the other facility such as the data center 96, this deficiency may be compensated by discharge from the power storage device 98.

In the example illustrated in FIG. 3, to reduce the price of the SOFC 14, the installed capacity of the SOFC 14 is designed so that the peak heat demand of the hospital 4 is not satisfied only by the waste heat of the SOFC 14, and the SOFC 14 is operated at a constant load of 100% regardless of the time by reducing the output scale of the SOFC 14. In this case, during the night when the waste heat of the SOFC 14 satisfies all heat demands (steam demand and/or hot water demand) of the hospital 4, the waste heat of the SOFC 14 satisfies all the demands of the hospital 4 and unnecessary waste heat of the SOFC 14 is converted into electric power or stored or radiated. During the day when the heat demand of the hospital 4 cannot be satisfied by the waste heat of the SOFC 14, the deficiency of the waste heat of the SOFC 14 relative to the heat demand is satisfied by the stored waste heat of the SOFC 14 stored at night or by using a boiler for the electric power stored in the power storage device 98 at night. The surplus electric power of the SOFC 14 is generally matched to the electric power demand of another facility, such as a data center, by charging and discharging the power storage device 98.

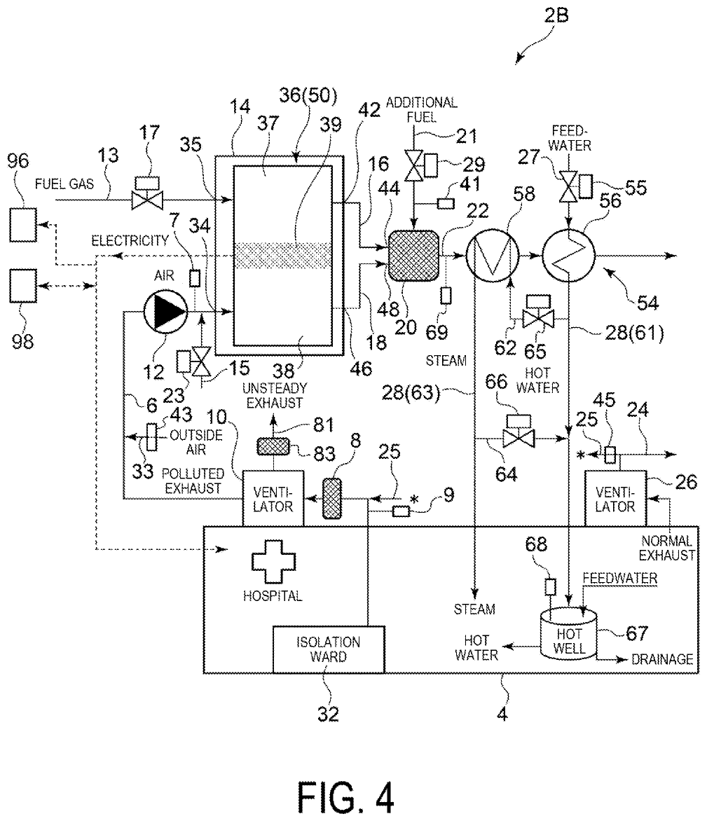

FIG. 4 is a schematic diagram illustrating a fuel cell system 2B, which is another embodiment of the fuel cell system 2. In the fuel cell system 2B illustrated in FIG. 4, reference signs common to the components of the fuel cell system 2A illustrated in FIG. 1 indicate the same components as the components of the fuel cell system 2A illustrated in FIG. 1 unless otherwise specified, and descriptions thereof are omitted.

The fuel cell system 2B illustrated in FIG. 4 differs from the configuration illustrated in FIG. 1 in that the heat demand of the hospital 4 is satisfied separately by hot water and by steam. In the illustrated embodiment, the fuel cell system 2B is provided with a heat exchange apparatus 54 for generating steam and hot water in the combustion gas line 22 through which gas combusted by the combustor 20 flows. The heat exchange apparatus 54 includes a first heat exchanger 56 and a second heat exchanger 58. The first heat exchanger 56 is provided in the combustion gas line 22 and is configured to generate hot water by heating the water supplied from the feedwater line 27 using the combustion gas generated at the combustor 20. The second heat exchanger 58 is an evaporator provided on the combustion gas line 22 upstream of the first heat exchanger 56 and configured to generate steam by using the combustion gas generated at the combustor 20.

As illustrated in FIG. 4, the fuel cell system 2B includes a plurality of heat supply lines 28. The plurality of heat supply lines 28 include a hot water supply line 61, an evaporator-supplied hot water line 62, a steam supply line 63, and an extracted steam line 64. The fuel cell system 2B includes a flow control valve 65 provided in the evaporator-supplied hot water line 62, a flow control valve 66 provided in the extracted steam line 64, and the hot well 67 provided in the hospital 4.

The hot water supply line 61 connects the first heat exchanger 56 and the hot well 67, and supplies the hot water generated at the first heat exchanger 56 to the hot well 67. The hot water stored in the hot well 67 is used to meet the hot water demand of the hospital 4.

The evaporator-supplied hot water line 62 branches from the hot water supply line 61 and is connected to the second heat exchanger 58, and supplies the hot water of the hot water supply line 61 to the second heat exchanger 58. The flow control valve 65 (flow regulator) is configured to adjust the flow rate of the hot water supplied from the hot water supply line 61 to the second heat exchanger 58.

The steam supply line 63 connects the second heat exchanger 58 and a steam utilization facility (not illustrated) of the hospital 4, and supplies the steam generated at the second heat exchanger 58 to the steam utilization facility of the hospital 4. The total amount of steam used at the steam utilization facility of the hospital 4 is the steam demand of the hospital 4. The steam is supplied to the steam utilization facility of the hospital 4 through the steam supply line 63 to meet this steam demand. The steam utilization facility may be, for example, a sterilization device (e.g., autoclave, cleaning equipment, air conditioning equipment, laundry room linen, or kitchen).

The extracted steam line 64 connects the steam supply line 63 and the hot water supply line 61, and is configured to bleed the steam of the steam supply line 63 and supply it to the hot water supply line 61. The flow control valve 66 (flow regulator) is configured to adjust the amount of steam supplied to the hospital 4 by adjusting the flow rate of the steam supplied from the steam supply line 63 to the hot water supply line 61.

In the configuration illustrated in FIG. 4, the hot water generated at the first heat exchanger 56 can be supplied to the hospital 4 by the hot water supply line 61, and the steam generated at the second heat exchanger 58 can be supplied to the hospital 4 by the steam supply line 63. Thus, the waste heat of the SOFC 14 and the combustion gas of the combustor 20 can be used to supply the steam and the hot water to the hospital 4 while purifying the polluted exhaust by causing it to pass through the high temperature region (power generating unit 36) of the SOFC 14.

The fuel cell system 2B illustrated in FIG. 4 is provided with a discharge line 81 capable of discharging polluted exhaust to the outside from the polluted exhaust line 6, and a filter 83 provided in the discharge line 81. In the example illustrated in the drawing, the discharge line 81 is configured to discharge the polluted exhaust from the ventilator 10 to the outside of the hospital 4, and the filter 83 has a function to remove contaminants such as bacteria and viruses. Thus, when the polluted exhaust must be discharged to the outside of the hospital 4 when, for example, the operation of the SOFC 14 is stopped, the polluted exhaust is purified upon passing through the filter 83 before being discharged to the outside of the hospital 4 as unsteady exhaust. Since the filter 83 is not operated regularly, the replacement frequency is low, and the preparation time, work time, and replacement parts required for the filter for the polluted exhaust can be reduced. Further, the cost can be reduced as compared with a case where the filter is used regularly.

In the fuel cell system 2B illustrated in FIG. 4, the installed capacity of the SOFC 14 and the number of SOFCs 14 are determined to satisfy design values (maximum amounts) for the amount of polluted exhaust from the hospital 4, the heat demand (steam demand and hot water demand), and the electric power demand (including a certain amount of external electric power demand such as a data center 96). The output of the SOFC 14 corresponding to these design values is set to the rated output of the SOFC 14, and the rated output of the SOFC 14 is set to the maximum output of the SOFC 14 or less. In the fuel cell system 2B illustrated in FIG. 4, the entire amount of polluted exhaust from the hospital 4 may be used as the intake air of the SOFC 14, and the operating state of the SOFC 14 may be controlled to satisfy both the heat demand and the electric power demand.

The fuel cell system 2B illustrated in FIG. 4 is provided with a controller 100 for controlling the electric output of the fuel cell system 2B and the amount of heat supplied (the amount of steam and the amount of hot water) to the fuel cell system 2B.

An example of the configuration and function of the controller 100 will be described below.

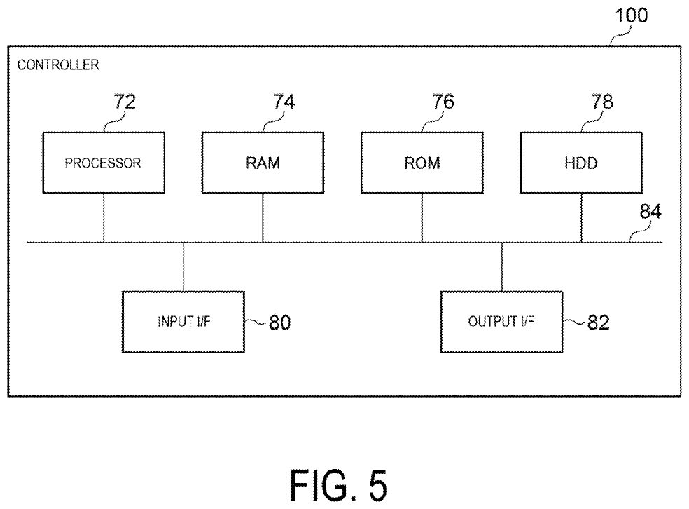

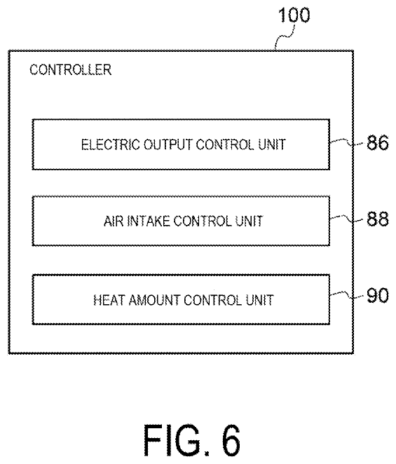

FIG. 5 is a diagram illustrating an example of a hardware configuration of the controller 100. FIG. 6 is a block diagram illustrating an example of the functional configuration of the controller 100 illustrated in FIG. 5.

As illustrated in FIG. 5, the controller 100 includes, for example, a processor 72, a random access memory (RAM) 74, a read only memory (ROM) 76, a hard disk drive (HDD) 78, an input I/F 80, and an output I/F 82. The controller 100 is configured by using a computer in which the above components are connected to each other via a bus 84. The controller 100 is not limited to the hardware configuration described above, and may be configured by a combination of a control circuit and a storage device. The controller 100 is configured by a computer executing a program that achieves the functions of the controller 100. The functions of each unit in the controller 100 described below are achieved by, for example, loading a program stored in the ROM 76 into the RAM 74 and executing the program at the processor 72, and by reading and writing data at the RAM 74 and the ROM 76.

As illustrated in FIG. 6, the controller 100 includes an electric output control unit 86, an air intake control unit 88, and a heat amount control unit 90. The electric output control unit 86 controls the electric output of the SOFC 14 mainly by controlling the degree of opening of the flow control valve 17 (see FIG. 4) to control the flow rate of the fuel gas supplied from the fuel electrode fuel line 13 to the SOFC 14, and also by controlling a power converter (not illustrated) such as a power conditioner. The air intake control unit 88 controls the air intake of the SOFC 14 mainly by controlling the blower 12. The heat amount control unit 90 controls the heat amount (amount of steam and amount of hot water) supplied to the hospital 4 by adjusting components such as the flow control valve 23, the flow control valve 29, the flow control valve 55, the flow control valve 65, and the flow control valve 66.

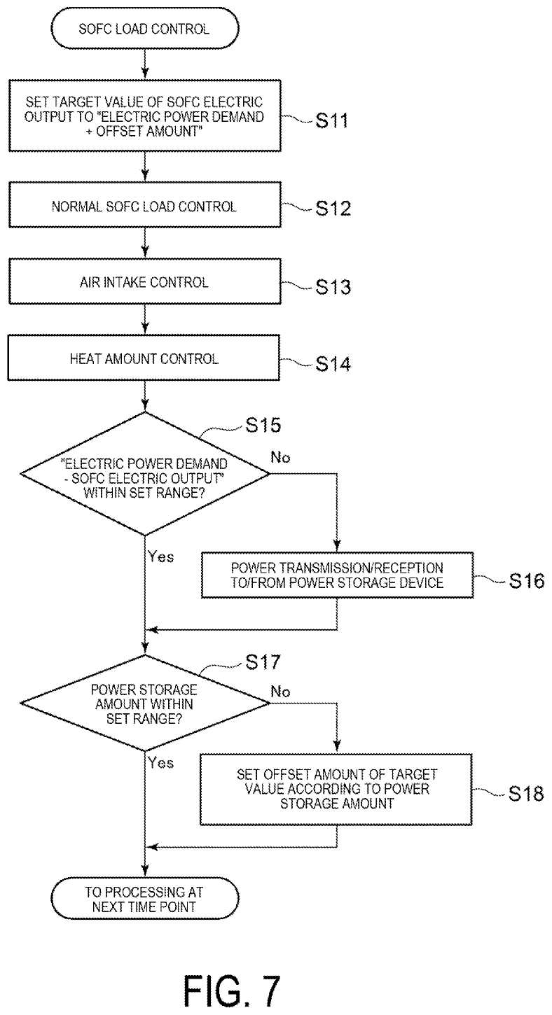

FIG. 7 is a diagram illustrating an example of a flow of schematic load control of the SOFC 14 using the controller 100 illustrated in FIG. 6.

As illustrated in FIG. 7, in S11, the electric output control unit 86 sets a target value Sve of the electric output of the SOFC 14 to the sum of an electric power demand De and an offset amount αe.

In S12, the electric output control unit 86 performs normal load control (control of fuel gas and air intake according to load fluctuation) of the SOFC 14, based on the target value SVe of the electric output set in S11. In S12, a target value SVf of the amount of fuel gas supplied to the fuel electrode 37 of the SOFC 14 and a target value SVa of the air intake of the SOFC 14 are set, corresponding to the target value SVe of the electric output set in S11.

In S13, the air intake control unit 88 controls the air intake of the SOFC 14 according to the amount of polluted exhaust discharged from the hospital 4. Details of S13 will be described later.

In S14, the heat amount control unit 90 controls the flow rate of additional fuel supplied from the additional fuel line 21 to the combustor 20 to meet the heat demand (steam demand and hot water demand) of the hospital 4. Details of S14 will be described later.

In S15, a determination is made as to whether a value obtained by subtracting the electric output of the SOFC 14 from the electric power demand De is within a set tolerance. In S15, in a case where it is determined that the value obtained by subtracting the electric output of the SOFC 14 from the electric power demand De is not within a set allowable range, in S16, excess or deficient electric output of the SOFC 14 relative to the electric power demand De is eliminated by transmission/reception to/from the power storage device 98 (discharge from or charge to the power storage device 98), and the processing proceeds to S17.

In S15, in a case where the value obtained by subtracting the electric output of the SOFC 14 from the electric power demand De is within a set allowable range, a determination is made in S17 as to whether the amount of power stored in the power storage device 98 is within the set allowable range. In S17, in a case where it is determined that the power storage amount of the power storage device 98 is within the set allowable range, the processing shifts to the processing of the next time point (returns to S11). In S17, in a case where it is determined that the amount of power stored in the power storage device 98 is not within the set allowable range, in S18, the offset amount αe (offset amount, of target value SVe of electric output of the SOFC 14, relative to the electric power demand De) corresponding to the amount of power stored in the power storage device 98 is set to eliminate an excess or deficient amount of power stored in the power storage device 98 relative to the tolerance.

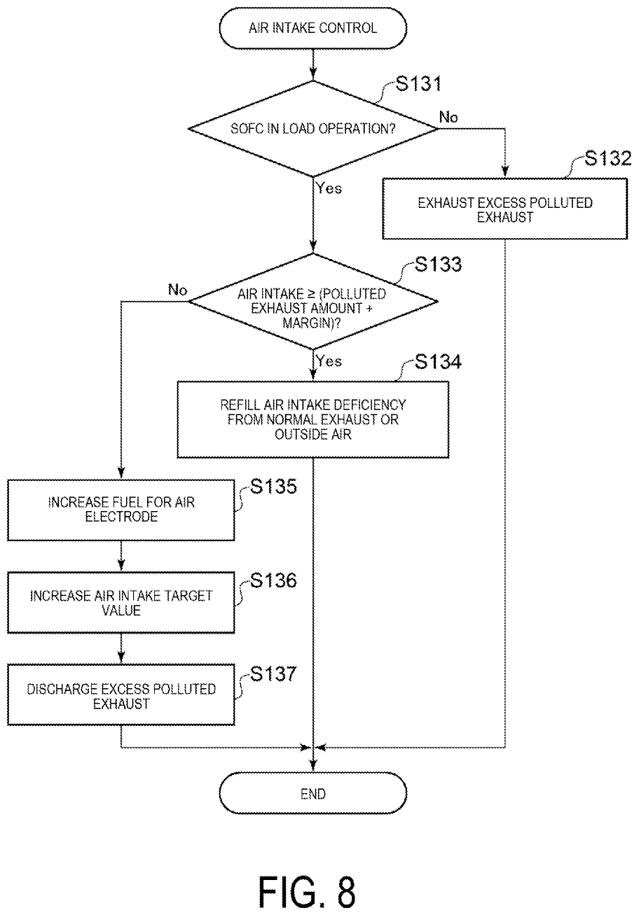

FIG. 8 is a diagram illustrating an example of a detailed flow of the air intake control illustrated in S13 of FIG. 7. The steps of FIG. 8 are executed by the air intake control unit 88 unless otherwise specified.

As illustrated in FIG. 8, in S131, a determination is made as to whether the SOFC 14 is in load operation. In S131, in a case where it is determined that the SOFC 14 is not in load operation, in S132, the polluted exhaust from the hospital 4 is discharged into the atmosphere from the discharge line 81 via the filter 83 by the ventilator 10 as unsteady exhaust. In the example illustrated in FIG. 4, the ventilator 10 is configured such that the exhaust destination of the exhaust can be changed between the SOFC 14 side (blower 12 side) in the polluted exhaust line 6 and the discharge line 81. However, the discharge line 81 may branch from downstream of the ventilator 10 in the polluted exhaust line 6. In this case, a shut-off valve (not illustrated) may be provided at a position immediately after the branch of the ventilator 10 in each of the polluted exhaust line 6 and the discharge line 81. The shut-off valve is configured to change the inflow destination of the polluted exhaust passing through the ventilator 10 between the SOFC 14 side in the polluted exhaust line 6 and the discharge line 81.

In S131, in a case where it is determined that the SOFC 14 is in load operation, in 5133, a determination is made as to whether the target value SVa of the air intake set in S12 is equal to or greater than the sum of a polluted exhaust amount Ep measured by the flow meter 9 and a predetermined margin. In other words, in S133, a determination is made as to whether the difference between the target value SVa of the air intake set in S12 and the polluted exhaust amount Ep measured by the flow meter 9 (SVa−Ep) is equal to or greater than a predetermined threshold value TH.

In S133, in a case where it is determined that the difference (SVa−Ep) is equal to or greater than the predetermined threshold value TH, in S134, the deficiency of air intake corresponding to this difference (SVa−Ep) is supplied from the normal exhaust or outside air. In S134, in a case where the deficiency of air intake corresponding to the difference (SVa−Ep) is supplied from normal exhaust, the degree of opening of the flow adjustment valve 45 is increased (the flow adjustment valve 45 is controlled to the open side) to increase the flow rate of the normal exhaust taken into the polluted exhaust line 6. In S134, in a case where the deficiency of air intake corresponding to the difference (SVa−Ep) is supplied from outside air, the degree of opening of the flow adjustment valve 43 is increased (the flow adjustment valve 43 is controlled to the open side) to increase the flow rate of the outside air taken into the polluted exhaust line 6.

In S133, in a case where it is determined that the difference (SVa−Ep) is not equal to or greater than the threshold value TH, in S135, the degree of opening of the flow control valve 23 is increased (the flow control valve 23 is controlled to the open side) to supply the fuel gas at a flow rate corresponding to the difference (SVa−Ep) to the air electrode 38, thereby increasing the flow rate of the fuel gas supplied from the air electrode fuel line 15 to the air electrode 38. In S136, the target value SVa of the air intake is set to the sum of the polluted exhaust amount Ep measured by the flow meter 9 and the predetermined margin (sum of the polluted exhaust amount Ep and the threshold value TH), and the rotational speed of the blower 12 is controlled such that the deviation between the set target value SVa and an air intake V of the SOFC 14 measured by the flow meter 7 is small.

In S137, a surplus of the polluted exhaust amount Ep for air intake is discharged from the ventilator 10 to the outside of the hospital 4 via the filter 83 as unsteady exhaust.

Thus, the polluted exhaust can be supplied to the SOFC 14 at a maximum by appropriately controlling the flow rate of the fuel gas supplied from the air electrode fuel line 15 to the air electrode 38 based on the polluted exhaust amount Ep. A decrease in the internal temperature of the SOFC 14 due to fluctuation in the polluted exhaust amount Ep can be suppressed by combustion (power generation chamber combustion) of the fuel gas supplied to the air electrode 38. Thus, electric power can be generated by the SOFC 14 while the reaction heat of the SOFC 14 is used to appropriately purify the discharged polluted exhaust, which fluctuates in amount as described below.

The flow rate of the fuel gas supplied from the air electrode fuel line 15 to the air electrode 38 can be controlled to an appropriate flow rate according to the difference between the target value SVa of the air intake of the SOFC 14 and the polluted exhaust amount Ep. As a result, the internal temperature of the SOFC 14 can be effectively prevented from dropping too low due to a fluctuation in the amount of polluted exhaust by combustion of the fuel gas supplied to the air electrode 38, and the discharged polluted exhaust, which fluctuates in amount, can be effectively purified by the reaction heat of the fuel cell.

Further, when the polluted exhaust amount Ep is deficient for the target value SVa of the air intake of the SOFC 14, the flow rate of the outside air or the normal exhaust, which are taken into the polluted exhaust line 6, can be increased, so that the desired output of the SOFC 14 can be achieved even when the polluted exhaust amount fluctuates.

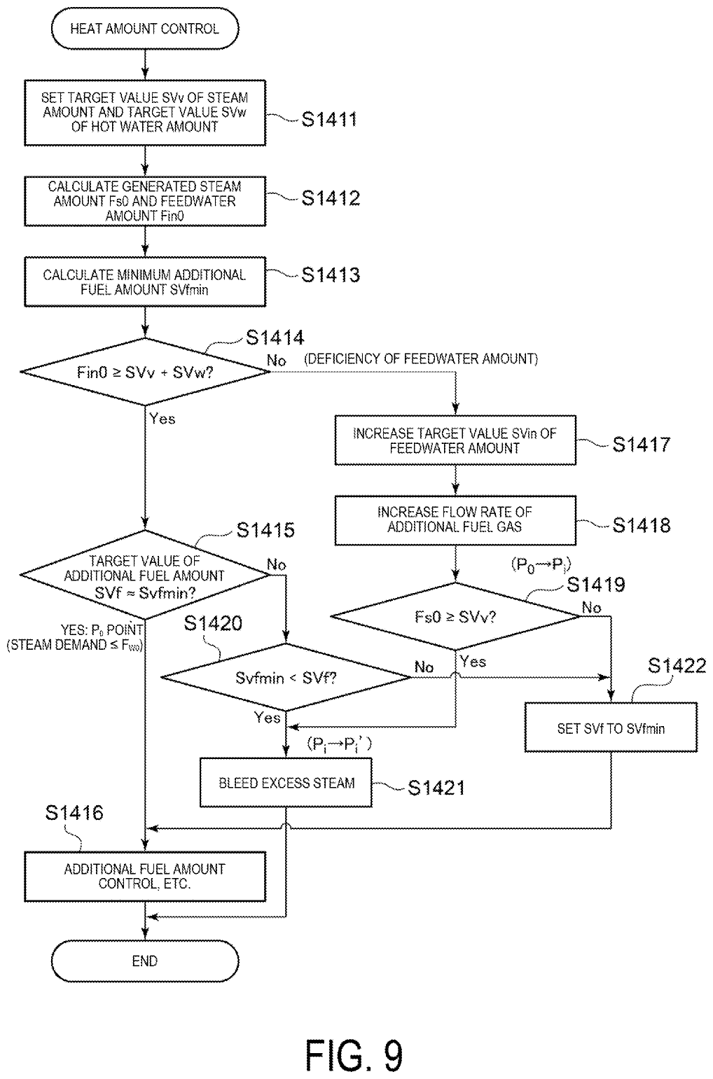

FIG. 9 is a diagram illustrating an example of a detailed flow of the heat amount control illustrated in S14 of FIG. 7. The steps of FIG. 9 are executed by the heat amount control unit 90 unless otherwise specified.

As illustrated in FIG. 9, in S1411, a target value SVv of the amount (flow rate) of steam supplied from the steam supply line 63 to the hospital 4 is set to the sum of the amount demanded Dv of the steam for the hospital 4 and the set offset amount av (SVv=Dv+αv). The target value SVw of the amount (flow rate) of hot water supplied from the hot water supply line 61 to the hospital 4 is set to the sum of the amount demanded Dw of the hot water for the hospital 4 and the set offset amount aw (SVw=Dw+αw). Here, the offset amount av and the offset amount aw are values set based on the amount of hot water stored in the hot well 67 measured by a hot well level sensor 68 and a predetermined margin.

Next, in S1412, a generated steam amount Fs0 being the flow rate of steam that can be generated by the second heat exchanger 58, and a feedwater amount Fin0 being the flow rate of water supplied from the feedwater line 27 to the first heat exchanger 56 are calculated based on an inlet gas temperature Tin of the second heat exchanger, which is the inlet temperature of the combustion gas in the second heat exchanger 58, measured by the temperature sensor 69, an air intake V of the SOFC 14 measured by the flow meter 7, an additional fuel amount G measured by the flow meter 41, set steam conditions (e.g., temperature and pressure of steam to be supplied to the hospital 4), and set hot water conditions (e.g., temperature of hot water to be supplied to the hospital 4).

Next, in S1413, to achieve the target value SVv of the steam amount set in S1411, a minimum additional fuel amount SVfmin being the minimum additional fuel amount to be supplied from the additional fuel line 21 to the combustor 20 is calculated.

Next, in S1414, a determination is made as to whether the feedwater amount Fin0 calculated in S1412 is equal to or greater than the sum of the steam amount target value SVv and the hot water amount target value SVw set in S1411 (whether Fin0≥SVv+SVw is satisfied).

In S1414, in a case where it is determined that Fin0≥SVv+SVw is satisfied, in S1415, a determination is made as to whether the target value SVf (previously calculated target value) of the additional fuel amount supplied from the additional fuel line 21 to the combustor 20 is substantially the same as the minimum additional fuel amount SVfmin calculated in S1413, that is, whether |SVf−SVfmin| is equal to or less than a threshold value.

In S1415, in a case where it is determined that SVf−SVfmin is equal to or less than the threshold value, in S1416, the flow control valve 29 is controlled to reduce the deviation between the target value SVf of the additional fuel amount and the flow rate of the additional fuel measured by the flow meter 41, thereby controlling the additional fuel amount supplied from the additional fuel line 21 to the combustor 20.

In S1416, the target value SVv of the steam amount is maintained, and the surplus of hot water supplied from the hot water supply line 61 to the hospital 4 relative to the hot water demand of the hospital 4 is stored in the hot well 67. When the hot well 67 is full of hot water, the surplus of hot water is drained or supplied again to the feedwater.

In S1414, in a case where it is determined that Fin0≥SVv+SVw is not satisfied, since the feedwater amount, which is the flow rate of water supplied from the feedwater line 27 to the first heat exchanger 56, is deficient, in S1417, the target value SVin of the feedwater amount is set to the sum of the target value SVv of the steam amount and the target value SVw of the hot water amount to increase the target value SVin of the feedwater amount.

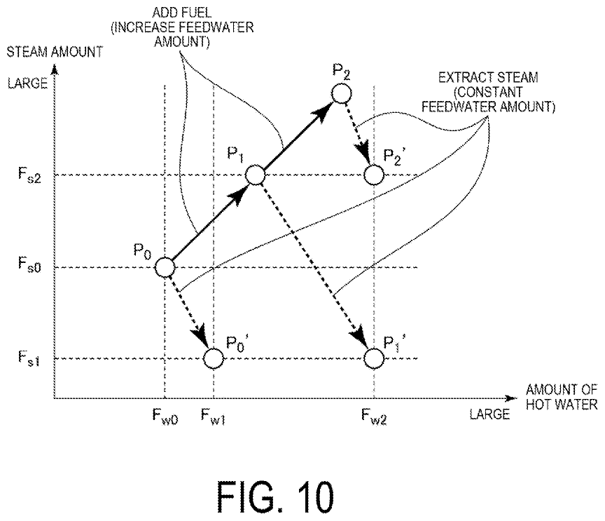

Next, in S1418, the degree of opening of the flow control valve 29 is increased according to the increase in the target value SVin of the feedwater amount in S1417, to thereby increase the additional fuel amount supplied from the additional fuel line 21 to the combustor 20 (see FIG. 10. In FIG. 10, a state Pi (i=0, 1, 2) refers to a state where as i increases, the feedwater amount increases.)

In S1419, a determination is made as to whether the generated steam amount Fs0 is equal to or greater than the target value SVv of the steam amount. In S1419, in a case where the generated steam amount Fs0 is equal to or greater than the target value SVv of the steam amount, in S1421, the degree of opening of the flow control valve 66 is increased to bleed excess steam from the steam supply line 63 to the hot water supply line 61 via the extracted steam line 64 so that the flow rate of steam supplied from the steam supply line 63 to the hospital 4 matches the steam amount demanded by the hospital 4 (that is, in FIG. 10, the state Pi shifts to the state Pi′ so that the required amount of hot water and steam can be ensured).

In S1419, in a case where it is determined that the generated steam amount Fs0 is not greater than or equal to the target value SVv of the steam amount, in S1422, the target value SVf of the additional fuel amount is set to the minimum additional fuel amount SVfmin.

In S1415, in a case where it is determined that the target value SVf of the additional fuel amount is not substantially the same as the minimum additional fuel amount SVfmin calculated in S1413, in S1420, a determination is made as to whether the minimum additional fuel amount SVfmin is smaller than the target value SVf of the additional fuel amount.

In S1420, in a case where it is determined that the minimum additional fuel amount SVfmin is smaller than the target value SVf of the additional fuel amount, in S1421, the degree of opening of the flow control valve 66 is increased so that the flow rate of the steam supplied from the steam supply line 63 to the hospital 4 matches the steam amount demanded by the hospital 4, and surplus steam is bled from the steam supply line 63 to the hot water supply line 61 via the extracted steam line 64.

In S1420, in a case where it is determined that the minimum additional fuel amount SVfmin is not smaller than the target value SVf of the additional fuel amount, in S1422, the target value SVf of the additional fuel amount is set to the minimum additional fuel amount SVfmin.

In the above heat amount control, when the steam demand and hot water demand of the hospital 4 cannot be satisfied by combustion of the exhaust fuel gas discharged from the SOFC 14, the steam demand and hot water demand of the hospital 4 can be satisfied by adding an appropriate amount of fuel from the additional fuel line 21 to the combustor 20.

According to the control illustrated in FIGS. 7 to 9, the SOFC 14 is operated according to the electric power demand of the hospital 4 and the additional fuel amount supplied to the combustor 20 is adjusted to satisfy the steam demand and the hot water demand of the hospital 4. As a result, the fuel cell system 2B can be operated to satisfy the electric power demand, steam demand and hot water demand of the hospital 4 by the steam of the steam supply line 63 and the hot water of the hot water supply line 61.

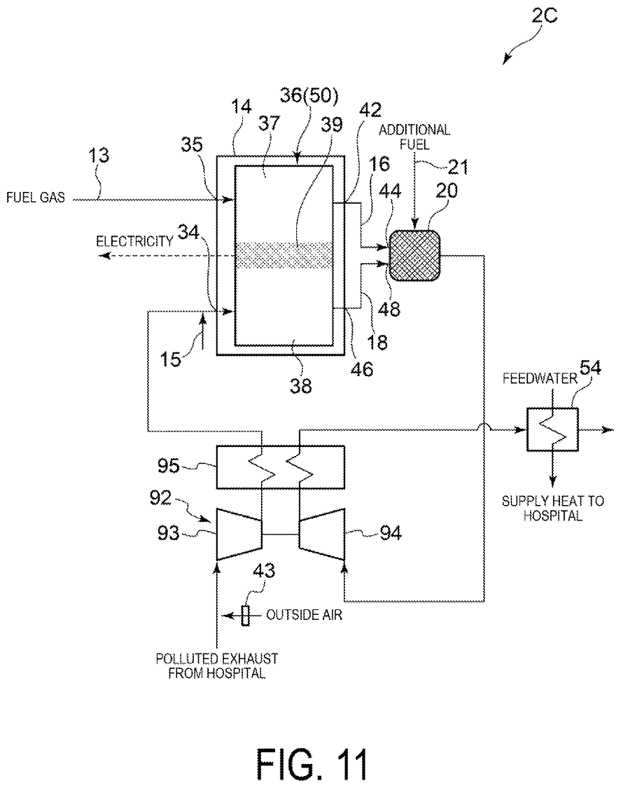

In the embodiment described above, the polluted exhaust discharged from the hospital 4 is supplied to the SOFC 14 by using the blower 12. However, as illustrated in FIG. 11, for example, the polluted exhaust discharged from the hospital 4 may be boosted by using the turbocharger 92 before being supplied to the SOFC 14.

FIG. 11 is a schematic diagram illustrating a portion of a fuel cell system 2C, which is another embodiment of the fuel cell system 2. In the fuel cell system 2C illustrated in FIG. 11, reference signs common to the components described above indicate the same components as the components in the fuel cell system 2C unless otherwise specified, and descriptions thereof are omitted.

In the exemplary configuration illustrated in FIG. 11, the compressor 93 of the turbocharger 92 is provided in the polluted exhaust line 6 that supplies polluted exhaust from a hospital to the air electrode 38 of the SOFC 14, and the turbine 94 of the turbocharger 92 is provided in the combustion gas line 22 downstream of the combustor 20. The combustion gas discharged from the combustor 20 flows into the turbine 94 through the combustion gas line 22, thereby rotating the turbine 94. The compressor 93 connected to the turbine 94 rotates integrally with the turbine 94, whereby the polluted exhaust of the polluted exhaust line 6 is compressed by the compressor 93 and supplied to the air electrode 38.

In the exemplary configuration illustrated in FIG. 11, a recuperator 95 is provided to heat the polluted exhaust downstream of the compressor 93 in the polluted exhaust line 6 using the combustion gas downstream of the turbine 94 in the combustion gas line 22.

According to the configuration illustrated in FIG. 11, thermal efficiency can be improved by compressing the polluted exhaust by the turbocharger 92, raising the temperature by the recuperator 95, and then supplying the polluted exhaust to the air electrode 38 of the SOFC 14.

The disclosure is not limited to the embodiments described above, and includes changes to the embodiments described above or a combination of the embodiments.

For example, in the control illustrated in FIG. 9, in S1418, the degree of opening of the flow control valve 29 is increased to increase the additional fuel amount supplied from the additional fuel line 21 to the combustor 20 according to an increase in the target value SVin of the feedwater amount in S1417. However, in S1418, the degree of opening of the flow control valve 17 may be increased according to an increase in the target value SVin of the feedwater amount to increase the flow rate of the fuel gas supplied from the fuel electrode fuel line 13 to the SOFC 14. In this case, additional fuel is supplied from the fuel electrode fuel line 13 to the combustor 20 via the SOFC 14, the fuel electrode fuel line 13 functions as the additional fuel line, and the flow control valve 17 functions as the additional fuel amount regulator.

For example, in the fuel cell systems 2A to 2C described above, an SOFC having a relatively high operating temperature is used as an example of a fuel cell. However, the fuel cell is not limited to an SOFC and may be a phosphoric acid fuel cell (PAFC) or a molten carbonate fuel cell (MCFC). However, from the viewpoint of effectively purifying polluted exhaust using the reaction heat of the fuel cell, the operating temperature of the fuel cell and the retention time at a high-temperature fuel cell part preferably exceed, for example, the condition specified as sterilization time in the Japanese Pharmacopoeia or an extrapolated condition thereof. The retention time is preferably 30 minutes at 190° C. or higher than 45 seconds at 300° C., which is the extrapolated condition thereof.

In the fuel cell systems 2A to 2C described above, the hospital 4 is used as an example of a facility that discharges polluted exhaust containing bacteria, viruses, odorous substances, or other contaminants that affect organisms (i.e., harmful substances that affect living organisms). However, the facility that discharges polluted exhaust is not limited to a hospital and may include a facility where contaminants are brought in, a facility in which contaminants multiply, or a facility in which contaminants are created. Such a facility may include a laboratory, a factory, or an isolation facility, which deal with contaminants such as bacteria or viruses. The contaminants contained in the polluted exhaust to be purified by the fuel cell may contain only bacteria, may contain only viruses, may contain only odorous substances that decompose at a high temperature, may contain only other harmful substances that decompose at a high temperature, or may contain a plurality of kinds of contaminants among the above.

For example, in S16 of FIG. 7, excess or deficient electric output of the SOFC 14 relative to the electric power demand De is solved by transmission/reception to/from the power storage device 98 (discharge from the power storage device 98 or charge to the power storage device 98), but the power storage device 98 is not essential in the fuel cell system 2. For example, in S15, in a case where it is determined that the electric power demand De minus the electric output of the SOFC 14 is not within a set normal operating range, a power mode may be executed, in which the flow rate of the fuel gas supplied from the fuel electrode fuel line 13 to the SOFC 14 and the air intake of the SOFC 14 are controlled to obtain an electric output exceeding the rated output of the SOFC 14, thereby increasing the electric output by increasing the current amount of the SOFC 14 within an allowable range. The discharge of the power storage device 98 and the power mode may be used together.

In S133 of FIG. 8, the measured value of the polluted exhaust amount is used as the polluted exhaust amount Ep, but the polluted exhaust amount Ep may be an estimated value or a planned value of the polluted exhaust amount.

The contents described in the above embodiments are grasped as follows, for example.

(1) A fuel cell system (e.g., the fuel cell system 2A described above) according to at least one embodiment of the disclosure, includes:

a fuel cell (e.g., the SOFC 14 described above) including a fuel electrode (e.g., the fuel electrode 37 described above) and an air electrode (e.g., the air electrode 38 described above);

a fuel electrode fuel line (e.g., the fuel electrode fuel line 13 described above) configured to supply fuel gas to the fuel electrode;

a polluted exhaust line (e.g., the polluted exhaust line 6 described above) configured to supply polluted exhaust containing contaminants discharged from a facility to the air electrode; and

an air electrode fuel line (e.g., the air electrode fuel line 15 described above), configured to supply fuel gas to the air electrode.

In the fuel cell system according to above (1), in a case where the flow rate of the polluted exhaust discharged from the facility via the polluted exhaust line increases, the air intake of the fuel cell increases, and when nothing is done, the temperature of the air electrode decreases and the action, of purifying the polluted exhaust by reaction heat of the fuel cell decreases. However, in the configuration of above (1), even when the air intake of the fuel cell has increased due to an increase in the flow rate of the polluted exhaust discharged from the facility via the polluted exhaust line, since the fuel gas is supplied from the air electrode fuel line to the air electrode and the fuel gas is combusted (power generation chamber combustion) on the air electrode side, a decrease in the internal temperature of the fuel cell due to an increase in the flow rate of the polluted exhaust can be suppressed by combustion heat on the air electrode side. Thus, electric power can be generated by the fuel cell while the reaction heat of the fuel cell is used to appropriately purify the discharged polluted exhaust, which fluctuates in amount.

(2) In some embodiments, the fuel cell system according to (1) above further includes

an outside air regulator (e.g., the flow adjustment valve 43 described above) capable of adjusting a flow rate of outside air taken into the polluted exhaust line.

With the fuel cell system according to above (2), when the amount of polluted exhaust discharged from the facility is small compared to the air intake required to generate the electric power required at the facility by the fuel cell, an appropriate amount of the outside air can be taken into the polluted exhaust line from the outside air regulator to meet the required amount of air intake to generate the electric power required at the facility by the fuel cell.

(3) In some embodiments, the fuel cell system according to (1) or (2) above further includes:

a normal exhaust supply line (e.g., the normal exhaust supply line 25 described above) capable of supplying normal exhaust from the facility to the polluted exhaust line, the normal exhaust being exhaust having a lower concentration of the contaminants than the polluted exhaust or exhaust not containing the contaminants; and

a normal exhaust regulator (e.g., the flow adjustment valve 45 described above) capable of adjusting a flow rate of the normal exhaust supplied from the normal exhaust supply line to the polluted exhaust line.

With the fuel cell system according to above (3), in a case where the amount of polluted exhaust discharged from the facility is small compared to the air intake required to generate electric power required at the facility by the fuel cell, an appropriate amount of the normal exhaust can be taken into the polluted exhaust line from the normal exhaust supply line to meet the required amount of air intake to generate the electric power required at the facility by the fuel cell.

(4) In some embodiments, the fuel cell system according to any one of (1) to (3) above further includes:

a discharge line (e.g., the discharge line 81 described above) capable of discharging the polluted exhaust to the outside from the polluted exhaust line; and

a filter (e.g., the filter 83 described above) provided at the discharge line.

With the fuel cell system according to above (4), the polluted exhaust discharged from the facility during, for example, a period where the fuel cell is not in operation can be discharged as unsteady exhaust to the outside of the facility via the filter.

(5) In some embodiments, the fuel cell system according to any one of (1) to (4) above, further includes:

an exhaust fuel gas line (e.g., the exhaust fuel gas line 16 described above) configured to supply exhaust fuel gas discharged from the fuel cell;

an exhaust air line (e.g., the exhaust air line 18 described above) configured to supply exhaust air discharged from the fuel cell;

a combustor (e.g., the combustor 20 described above) configured to mix and combust the exhaust fuel gas supplied from the exhaust fuel gas line and the exhaust air supplied from the exhaust air line;

a combustion gas line (e.g., the combustion gas line 22 described above) through which combustion gas generated at the combustor flows;

a heat exchange apparatus (e.g., the heat exchange apparatus 54 described above) that is provided in the combustion gas line and generates at least one of steam and hot water by using the combustion gas generated at the combustor; and

at least one heat supply line (e.g., the heat supply line 28, the hot water supply line 61, and the steam supply line 63 described above) configured to supply, to the facility, the at least one of steam and hot water generated at the heat exchange apparatus.

With the fuel cell system according to (5) above, the exhaust fuel gas discharged from the fuel cell is combusted by the combustor using the exhaust air discharged from the fuel cell to generate combustion gas, and steam and/or hot water generated at the heat exchange apparatus using the combustion gas can be supplied to the facility via the heat supply line. Thus, the steam and/or hot water generated at the heat exchange apparatus can be used to satisfy the steam demand and hot water demand of the facility while the polluted exhaust discharged from the facility is purified.

(6) In some embodiments, the fuel cell system according to (5) above further includes an additional fuel line (e.g., the additional fuel line 21 described above) configured to supply additional fuel to the combustor.

With the fuel cell system according to (6) above, the heat amount (the steam amount and/or the hot water amount) to be supplied to the facility can be adjusted by adjusting the additional fuel amount supplied to the combustor. Thus, for example, the electric power demand of the facility can be satisfied with the electric output of the fuel cell, and the fuel cell system can be operated in a manner to satisfy the steam demand and/or the hot water demand of the facility by adjusting the additional fuel amount supplied to the combustor.

(7) In some embodiments, in the fuel cell system according to (5) or (6) above,

the heat exchange apparatus includes a first heat exchanger (e.g., the first heat exchanger 56 described above) configured to generate hot water using the combustion gas generated at the combustor,

the at least one heat supply line includes a hot water supply line (e.g., the hot water supply line 61 described above) configured to supply, to the facility, hot water generated at the first heat exchanger, and

the fuel cell system further includes a hot well (e.g., the hot well 67 described above) connected to the hot water supply line.

With the fuel cell system according to (7) above, for example, since it is possible to store hot water in the hot well by utilizing the waste heat of the fuel cell at night or other times when the hot water demand is low, and supply the hot water to the facility from the hot well during the day when the demand for hot water is high, an increase in the installed capacity of the fuel cell can be suppressed, which suppresses an increase in the equipment costs of the fuel cell.

(8) In some embodiments, in the fuel cell system according to (7) above,

the heat exchange apparatus includes a second heat exchanger (e.g., the second heat exchanger 58 described above) upstream of the first heat exchanger in the combustion gas line, the second heat exchanger being configured to generate steam using combustion gas generated at the combustor, and

the at least one heat supply line includes a steam supply line (e.g., the steam supply line 63 described above) configured to supply, to the facility, the steam generated at the second heat exchanger.

With the fuel cell system according to (8) above, the hot water generated at the first heat exchanger can be supplied to the facility by the hot water supply line, and the steam generated at the second heat exchanger can be supplied to the facility by the steam supply line. Thus, the waste heat of the fuel cell and the combustion gas of the combustor can be used to supply steam and hot water to the facility while the polluted exhaust is purified by the reaction heat of the fuel cell.

(9) In some embodiments, the fuel cell system according to any one of (1) to (8) above further includes:

a flow regulator (e.g., the flow control valve 23 described above) capable of adjusting a flow rate of fuel gas supplied from the air electrode fuel line to the air electrode; and

a controller (e.g., the controller 100 described above) configured to control the flow regulator,

wherein the controller is configured to control the flow regulator based on a polluted exhaust amount (e.g., the polluted exhaust amount Ep described above) being a flow rate of the polluted exhaust discharged from the facility.

With the fuel cell system according to (9) above, by appropriately controlling the flow rate of the fuel gas supplied from the air electrode fuel line to the air electrode based on the polluted exhaust amount, a decrease in the internal temperature of the fuel cell due to a fluctuation in the amount of polluted exhaust can be suppressed by combustion (power generation chamber combustion) of the fuel gas supplied to the air electrode. Thus, electric power can be generated by the fuel cell while the reaction heat of the fuel cell is used to appropriately purify the discharged polluted exhaust, which fluctuates in amount.

(10) In some embodiments, in the fuel cell system according to (9) above,

when a difference between an air intake target value (e.g., the target value SVa described above) of the fuel cell and the polluted exhaust amount (e.g., the polluted exhaust amount Ep described above) is less than a threshold value (e.g., the threshold value TH described above),

the controller is configured to control the flow regulator to supply the fuel gas to the air electrode at a flow rate corresponding to the difference between the air intake target value and the polluted exhaust amount.

With the fuel cell system according to (10) above, since the flow rate of the fuel gas supplied from the air electrode fuel line to the air electrode can be controlled to an appropriate flow rate according to the difference between the air intake target value of the fuel cell and the polluted exhaust amount, a decrease in the internal temperature of the fuel cell due to fluctuation in the amount of polluted exhaust can be suppressed by combustion (power generation chamber combustion) of the fuel gas supplied to the air electrode. Thus, electric power can be generated by the fuel cell while the reaction heat of the fuel cell is used to appropriately purify the discharged polluted exhaust, which fluctuates in amount.

(11) In some embodiments, the fuel cell system according to (9) or (10) above further includes

an outside air regulator (e.g., the flow adjustment valve 43 described above) capable of adjusting a flow rate of outside air taken into the polluted exhaust line, wherein

when the difference between the air intake target value of the fuel cell and the polluted exhaust amount is equal to or greater than a threshold value (e.g., the threshold value TH described above), the controller is configured to control the outside air regulator to increase the flow rate of the outside air taken into the polluted exhaust line.

With the fuel cell system according to (11) above, when the amount of polluted exhaust is deficient for the air intake target value, the flow rate of the outside air taken into the polluted exhaust line can be increased. As a result, desired output of the fuel cell can be achieved even when the amount of polluted exhaust fluctuates.

(12) In some embodiments, the fuel cell system according to (9) or (10) above further includes:

a normal exhaust supply line (e.g., the normal exhaust supply line 25 described above) capable of supplying normal exhaust from the facility to the polluted exhaust line, the normal exhaust being exhaust having a lower concentration of the contaminants than the polluted exhaust, or exhaust not containing the contaminants; and

a normal exhaust regulator (e.g., the flow adjustment valve 45 described above) capable of adjusting a flow rate of the normal exhaust supplied from the normal exhaust supply line to the polluted exhaust line,

wherein

when the difference between the air intake target value of the fuel cell and the polluted exhaust amount is equal to or greater than a threshold value (e.g., the threshold value TH described above), the controller is configured to control the normal exhaust regulator in a manner to increase the flow rate of the normal exhaust supplied from the normal exhaust supply line to the polluted exhaust line.

With the fuel cell system according to (12) above, when the amount of polluted exhaust is deficient for the air intake target value, the flow rate of the normal exhaust taken into the polluted exhaust line can be increased. As a result, desired output of the fuel cell can be achieved even when the amount of polluted exhaust fluctuates.

(13) In some embodiments, in the fuel cell system according to any one of (9) to (12) above, when the difference between the air intake target value of the fuel cell and the polluted exhaust amount is less than a threshold value (e.g., the threshold value TH described above), the controller is configured to increase the air intake target value.

With the fuel cell system according to (13) above, the total amount of the polluted exhaust discharged from the facility can be supplied to the air electrode of the fuel cell, and the total amount of the polluted exhaust discharged from the facility can be purified by the reaction heat of the fuel cell.

(14) In some embodiments,

the fuel cell system according to (8) above further includes:

an additional fuel line (e.g., the additional fuel line 21 described above) configured to add fuel to the combustor;

an additional fuel regulator (e.g., the flow control valve 29 described above) configured to adjust an additional fuel amount being a flow rate of fuel added from the additional fuel line to the combustor; and

a controller (e.g., the controller 100 described above) configured to control the additional fuel regulator,

wherein

the controller is configured to control the additional fuel regulator to meet a steam demand and a hot water demand of the facility with steam from the steam supply line and hot water from the hot water supply line.

With the fuel cell system according to (14) above, even when the steam demand and hot water demand of the facility cannot be satisfied only by the combustion of the exhaust fuel gas discharged from the fuel cell, the steam demand and hot water demand of the facility can be satisfied by adding an appropriate amount of fuel from the additional fuel line to the combustor.

(15) In a method of operating a fuel cell system (e.g., the fuel cell system 2B described above) according to at least one embodiment of the disclosure,

the fuel cell system includes:

a fuel cell (e.g., the SOFC 14 described above) including a fuel electrode (e.g., the fuel electrode 37 described above) and an air electrode (e.g., the air electrode 38 described above);

a fuel electrode fuel line (e.g., the fuel electrode fuel line 13 described above) configured to supply fuel gas to the fuel electrode;

a polluted exhaust line (e.g., the polluted exhaust line 6 described above) configured to supply polluted exhaust containing contaminants discharged from a facility to the air electrode; and

an air electrode fuel line (e.g., the air electrode fuel line 15 described above), configured to supply fuel gas to the air electrode.

The method of operating the fuel cell system includes:

adjusting a flow rate of fuel gas supplied from the air electrode fuel line to the air electrode based on a polluted exhaust amount (e.g., the polluted exhaust amount Ep described above) being an amount of the polluted exhaust discharged from the facility.

In accordance with the method of operating a fuel cell system according to (15) above, a decrease in the internal temperature of the fuel cell due to fluctuation in the amount of polluted exhaust amount can be suppressed, by combustion (power generation chamber combustion) of the fuel gas supplied to the air electrode, by appropriately adjusting the flow rate of the fuel gas supplied from the air electrode fuel line to the air electrode based on the amount of polluted exhaust. Thus, electric power can be generated by the fuel cell while the reaction heat of the fuel cell is used to appropriately purify the discharged polluted exhaust, which fluctuates in amount.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A fuel cell system comprising:
a fuel cell including a fuel electrode and an air electrode;
a fuel electrode fuel line configured to supply fuel gas to the fuel electrode;
a polluted exhaust line configured to supply polluted exhaust containing contaminants discharged from a facility to the air electrode; and
an air electrode fuel line configured to supply fuel gas to the air electrode.

2. The fuel cell system according to claim 1, further comprising
an outside air regulator capable of adjusting a flow rate of outside air taken into the polluted exhaust line.

3. The fuel cell system according to claim 1, further comprising:
a normal exhaust supply line capable of supplying normal exhaust from the facility to the polluted exhaust line, the normal exhaust being exhaust having a lower concentration of the contaminants than the polluted exhaust or exhaust not containing the contaminants; and
a normal exhaust regulator capable of adjusting a flow rate of the normal exhaust supplied from the normal exhaust supply line to the polluted exhaust line.

4. The fuel cell system according to claim 1, further comprising:
a discharge line capable of discharging the polluted exhaust to the outside from the polluted exhaust line; and
a filter provided at the discharge line.

5. The fuel cell system according to claim 1, further comprising:
an exhaust fuel gas line configured to supply exhaust fuel gas discharged from the fuel cell;
an exhaust air line configured to supply exhaust air discharged from the fuel cell;
a combustor configured to mix and combust the exhaust fuel gas supplied from the exhaust fuel gas line and the exhaust air supplied from the exhaust air line;
a combustion gas line through which combustion gas generated at the combustor flows;
a heat exchange apparatus that is provided in the combustion gas line and generates at least one of steam and hot water by using the combustion gas generated at the combustor; and
at least one heat supply line configured to supply, to the facility, the at least one of steam and hot water generated at the heat exchange apparatus.

6. The fuel cell system according to claim 5, further comprising
an additional fuel line configured to supply additional fuel to the combustor.

7. The fuel cell system according to claim 5, wherein
the heat exchange apparatus comprises a first heat exchanger configured to generate hot water using the combustion gas generated at the combustor,
the at least one heat supply line comprises a hot water supply line configured to supply, to the facility, hot water generated at the first heat exchanger, and
the fuel cell system further comprises a hot well connected to the hot water supply line.

8. The fuel cell system according to claim 7, wherein
the heat exchange apparatus comprises a second heat exchanger upstream of the first heat exchanger in the combustion gas line, the second heat exchanger being configured to generate steam using the combustion gas generated at the combustor, and
the at least one heat supply line comprises a steam supply line configured to supply, to the facility, the steam generated at the second heat exchanger.

9. The fuel cell system according to claim 1, further comprising:
a flow regulator capable of adjusting a flow rate of the fuel gas supplied from the air electrode fuel line to the air electrode; and
a controller configured to control the flow regulator, wherein
the controller is configured to control the flow regulator based on a polluted exhaust amount being a flow rate of the polluted exhaust discharged from the facility.

10. The fuel cell system according to claim 9, wherein
when a difference between an air intake target value of the fuel cell and the polluted exhaust amount is less than a threshold value, the controller is configured to control the flow regulator to supply the fuel gas to the air electrode at a flow rate corresponding to the difference between the air intake target value and the polluted exhaust amount.

11. The fuel cell system according to claim 9, further comprising:
an outside air regulator capable of adjusting a flow rate of outside air taken into the polluted exhaust line, wherein
when the difference between the air intake target value of the fuel cell and the polluted exhaust amount is equal to or greater than a threshold value, the controller is configured to control the outside air regulator to increase the flow rate of the outside air taken into the polluted exhaust line.

12. The fuel cell system according to claim 9, further comprising:
a normal exhaust supply line capable of supplying normal exhaust from the facility to the polluted exhaust line, the normal exhaust being exhaust having a lower concentration of the contaminants than the polluted exhaust or exhaust not containing the contaminants; and
a normal exhaust regulator capable of adjusting a flow rate of the normal exhaust supplied from the normal exhaust supply line to the polluted exhaust line, wherein
when the difference between the air intake target value of the fuel cell and the polluted exhaust amount is equal to or greater than a threshold value, the controller is configured to control the normal exhaust regulator to increase the flow rate of the normal exhaust supplied from the normal exhaust supply line to the polluted exhaust line.

13. The fuel cell system according to claim 9, wherein
when the difference between the air intake target value of the fuel cell and the polluted exhaust amount is less than a threshold value, the controller is configured to increase the air intake target value.

14. The fuel cell system according to claim 8, further comprising:
an additional fuel line configured to add fuel to the combustor;
an additional fuel regulator configured to adjust an additional fuel amount being a flow rate of fuel added from the additional fuel line to the combustor; and
a controller configured to control the additional fuel regulator, wherein the controller is configured to control the additional fuel regulator to meet a steam demand and a hot water demand of the facility with steam from the steam supply line and hot water from the hot water supply line.

15. A method of operating a fuel cell system,
the fuel cell system comprising:
a fuel cell including a fuel electrode and an air electrode;
a fuel electrode fuel line configured to supply fuel gas to the fuel electrode;
a polluted exhaust line configured to supply polluted exhaust containing contaminants discharged from a facility to the air electrode; and
an air electrode fuel line configured to supply fuel gas to the air electrode,
the method of operating the fuel cell system comprising:
adjusting a flow rate of fuel gas supplied from the air electrode fuel line to the air electrode based on a polluted exhaust amount being an amount of the polluted exhaust discharged from the facility.
